(19) United States
(12) Patent Application Publication
(10) Pub. No.: US 2026/0117587 A1
(43) Pub. Date: Apr. 30, 2026

(54) SLIDING CURTAIN WITH ADJUSTABLE WIDTH MECHANISM

(71) Applicant: HANGZHOU GIPUTA CLOTHING CO., LTD., Hangzhou (CN)

(72) Inventors: Yu PAN, Hangzhou (CN); Michael Alexander MAYER, Hangzhou (CN)

(73) Assignee: HANGZHOU GIPUTA CLOTHING CO., LTD., Hangzhou (CN)

(21) Appl. No.: 19/358,113

(22) Filed: Oct. 14, 2025

(30) Foreign Application Priority Data
Oct. 30, 2024 (CN) 2024226279621

(51) Int. Cl. E06B 9/322; E06B 9/262

(52) U.S. Cl. CPC E06B 9/322; E06B 9/262; E06B 2009/2625

(57) ABSTRACT

The present invention relates to a sliding curtain with adjustable width mechanism, belonging to the technical field of sliding curtains. The sliding curtain comprises an adjustable upper rail assembly, a light-shielding assembly, a telescopic lower rail assembly, and a pull-cord driving device. The adjustable upper rail assembly includes a main body portion and an adjustable portion connected to the main body portion, wherein the width of the adjustable portion is adjustable. The adjustable upper rail assembly is configured to be installed on a surface of a window frame. The light-shielding assembly is mounted on the adjustable upper rail assembly. The telescopic lower rail assembly is located below the light-shielding assembly and is connected to the light-shielding assembly, wherein the width of the telescopic lower rail assembly is adjustable. The pull-cord driving device is configured to control the raising and lowering of the telescopic lower rail assembly.

### FILED OF THE INVENTION

The present invention relates to the technical field of sliding curtains, and more particularly to a sliding curtain with an adjustable width mechanism.

### BACKGROUND OF THE INVENTION

Sliding curtains are one of the common types of indoor curtains in modern households. Most sliding curtains currently available on the market are custom-made products tailored to the size of a user’s window. However, due to measurement errors, if the curtain is manufactured with excessive width, the buyer cannot install or use it, and the seller cannot resell it. Returning the curtain to the factory for modification involves high shipping costs and long turnaround times, which results in a dual loss of time and money for both parties.

### SUMMARY OF THE INVENTION

The present invention is directed to providing sliding curtain with an adjustable width mechanism, aiming at addressing the technical problems of the width of the sliding curtain is non-adjustable found in the prior art.

To achieve the foregoing objective, the present invention adopts the following technical solution:

A sliding curtain with adjustable width mechanism, comprising:

an adjustable upper rail assembly, including a main body portion and an adjustable portion connected to the main body portion, wherein a width of the adjustable portion is adjustable; the adjustable upper rail assembly is configured for installation on a surface of a window frame;

a light-shielding assembly, mounted on the adjustable upper rail assembly;

a telescopic lower rail assembly, located below the light-shielding assembly, wherein the telescopic lower rail assembly is connected to the light-shielding assembly, and a width of the telescopic lower rail assembly is adjustable;

a pull-cord driving device, connected to the adjustable upper rail assembly, the light-shielding assembly, and the telescopic lower rail assembly, wherein the pull-cord driving device is configured to control raising and lowering of the telescopic lower rail assembly.

Further, the main body portion is a middle rail, the adjustable portion is a side rail, and the side rail is slidably connected to the middle rail; width adjustment is achieved by sliding the side rail inwardly or outwardly relative to the middle rail.

Further, the main body portion is a plate structure, the adjustable portion is a rail section, the rail section is connected to the plate structure, and the rail section includes a plurality of connected segment bodies; the length of the rail section can be adjusted by breaking the segment bodies.

Further, the adjustable portion is a foldable soft rail, at least one end of the main body portion is provided with the foldable soft rail, the foldable soft rail comprises a plurality of pleats arranged in sequence, and the foldable soft rail can be laterally expanded or contracted and stacked.

Further, the telescopic lower rail assembly comprises:

a second inner rail, provided with a bottom plate groove for connection with the light-shielding assembly;

a second outer rail, sleeved on the second inner rail and slidably connected to the second inner rail, wherein the second outer rail is provided with a bottom plate positioning rib for limiting the second inner rail.

Further, the telescopic lower rail assembly comprises:

a bracket, adapted to the pull-cord driving device;

an outer rail, slidably connected to the bracket;

an inner rail, slidably connected to the outer rail and the bracket; the outer rail and the inner rail are capable of relative sliding while the bracket remains stationary.

Further, the sliding curtain with adjustable width mechanism comprising a cord fastener, wherein the cord fastener includes:

a dome-shaped snap,

a C-shaped snap positioned above the dome-shaped snap, the C-shaped snap having a through hole extending vertically;

wherein after a pull cord of the pull-cord driving device passes through and is fixed below the through hole, the dome-shaped snap is engaged with the light-shielding assembly, and the C-shaped snap is engaged with the adjustable upper rail assembly, thereby achieving bidirectional fixation of the adjustable upper rail assembly and the light-shielding assembly.

Further, a bottom end of the light-shielding assembly is engaged with the telescopic lower rail assembly.

Further, a top end of the light-shielding assembly is engaged with the adjustable upper rail assembly.

The beneficial effects of the present invention are as follows:

Compared with the prior art, the present invention provides a sliding curtain with adjustable width mechanism. Both the upper and lower rails of the curtain adopt a modular adjustable structure, allowing the rails to retract inward according to the width of the cut curtain fabric. As a result, the overall width of the curtain can be adjusted. This design overcomes the technical limitation in the prior art, where conventional spring-loaded sliding curtains have a fixed width and cannot be adjusted.

### BRIEF DESCRIPTION OF THE DRAWINGS

In order to more clearly illustrate the technical solutions in the embodiments of the present invention, the drawings required for describing the embodiments or the prior art are briefly introduced below. It should be understood that the drawings described below only illustrate some embodiments of the present invention. Those skilled in the art can derive other drawings based on these figures without engaging in inventive labor.

FIG. 1 is a schematic view of the structure of a sliding curtain with adjustable width mechanism according to Embodiment 1 of the present invention;

FIG. 2 is an exploded view of the sliding curtain with adjustable width mechanism according to Embodiment 1 of the present invention;

FIG. 3 is a schematic view of the adjustable upper rail assembly used in the sliding curtain with adjustable width mechanism according to Embodiment 1 of the present invention, view 1;

FIG. 4 is a schematic view of the adjustable upper rail assembly used in the sliding curtain with adjustable width mechanism according to Embodiment 1 of the present invention, view 2;

FIG. 5 is a schematic view of the light-shielding assembly used in the sliding curtain with adjustable width mechanism according to Embodiment 1 of the present invention;

FIG. 6 is an exploded view of a telescopic lower rail assembly used in the sliding curtain with adjustable width mechanism according to Embodiment 1 of the present invention;

FIG. 7 is a schematic view of the telescopic lower rail assembly used in the sliding curtain with adjustable width mechanism according to Embodiment 1 of the present invention, view 1;

FIG. 8 is a schematic view of the telescopic lower rail assembly used in the sliding curtain with adjustable width mechanism according to Embodiment 1 of the present invention, view 2;

FIG. 9 is a schematic view of the telescopic lower rail assembly used in the sliding curtain with adjustable width mechanism according to Embodiment 1 of the present invention, view 3;

FIG. 10 is a schematic view of the telescopic lower rail assembly used in the sliding curtain with adjustable width mechanism according to Embodiment 1 of the present invention, view 4;

FIG. 11 is a schematic view of the telescopic lower rail assembly used in the sliding curtain with adjustable width mechanism according to Embodiment 1 of the present invention, view 5;

FIG. 12 is an exploded view of the sliding curtain with adjustable width mechanism according to Embodiment 2 of the present invention;

FIG. 13 is a schematic view of the sliding curtain with adjustable width mechanism according to Embodiment 2 of the present invention;

FIG. 14 is a schematic view of the adjustable upper rail assembly used in the sliding curtain with adjustable width mechanism according to Embodiment 2 of the present invention;

FIG. 15 is a schematic view of the top plate used in the sliding curtain with adjustable width mechanism according to Embodiment 2 of the present invention;

FIG. 16 is a schematic view of the cord buckle structure used in the sliding curtain with adjustable width mechanism according to Embodiment 2 of the present invention;

FIG. 17 is a schematic view of the adjustable upper rail assembly used in the sliding curtain with adjustable width mechanism according to Embodiment 3 of the present invention, view 1;

FIG. 18 is a schematic view of the adjustable upper rail assembly used in the sliding curtain with adjustable width mechanism according to Embodiment 3 of the present invention, view 2;

FIG. 19 is a schematic view of the adjustable upper rail assembly used in the sliding curtain with adjustable width mechanism according to Embodiment 4 of the present invention, view 1;

FIG. 20 is a schematic view of the adjustable upper rail assembly used in the sliding curtain with adjustable width mechanism according to Embodiment 4 of the present invention, view 2.

### Description of reference numerals:

1 — adjustable upper rail assembly; 11 — middle rail; 12 — side rail; 13 — top surface of middle rail; 14 — sliding groove of side rail; 15 — cord buckle groove; 16 — top plate groove; 17 — top surface of side rail; 18 — supporting sliding rib; 11b — second top surface; 12b — lower clamping rib; 13b — C-shaped clamping groove; 14b — sidewall snap-fit; 15b — rail section; 11c — third top surface; 12c — foldable soft rail; 11d — fourth top surface; 12d — second rail section; 13d — baffle plate; 14d — wiring groove; 15d — limiting groove; 16d — sidewall snap-fit.

2 — light-shielding assembly; 21 — top plate; 211 — upper clamping rib; 212 — cord buckle hole; 22 — curtain fabric; 23 — bottom plate; 24 — wire hole.

3 — telescopic lower rail assembly; 31 — outer rail; 311 — upper sliding groove; 312 — snap-fit stop rib; 313 — first lower sliding groove; 314 — first snap-fit hole; 32 — outer rail end cap; 33 — inner rail; 331 — sliding arm; 332 — bottom plate groove; 333 — second lower sliding groove; 334 — second snap-fit hole; 34 — inner rail end cap; 35 — snap-fit member; 36 — bracket; 361 — limiting groove; 362 — turning groove; 363 — high-position sliding rib; 364 — low-position sliding rib; 37 — turning shaft; 31b — second outer rail; 32b — second inner rail; 33b — bottom plate positioning rib; 34b — bottom plate groove.

4 — pull cord driving device.

5 — cord buckle; 51 — dome-shaped snap-fit; 52 — C-shaped snap-fit; 53 — wire hole.

### DETAILED DESCRIPTION OF THE PREFERRED EMBODIMENTS

In order to make the technical problem to be solved, the technical solution, and the beneficial effects of the present invention more apparent, the invention is further described in detail below in conjunction with the drawings and specific embodiments. It should be understood that the specific embodiments described herein are merely intended to illustrate the invention and are not to be construed as limiting its scope.

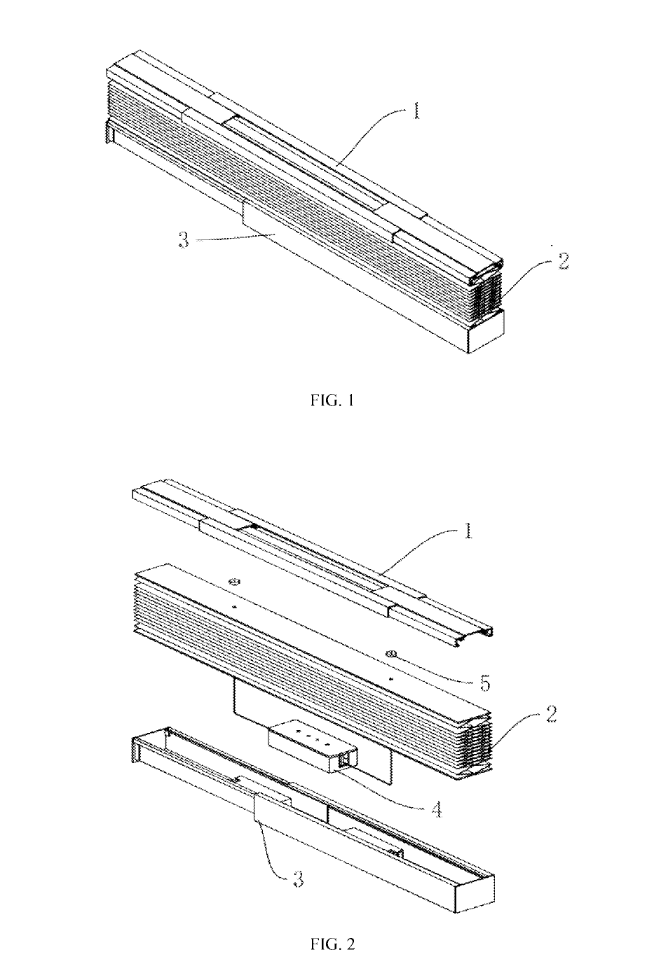

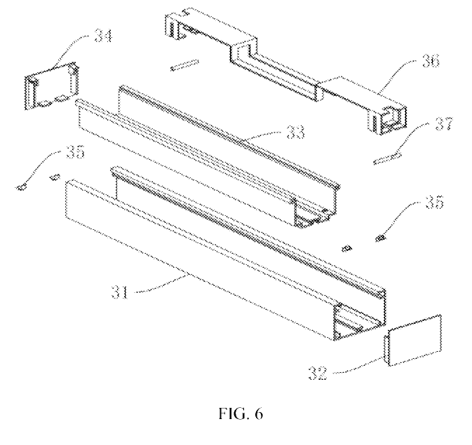

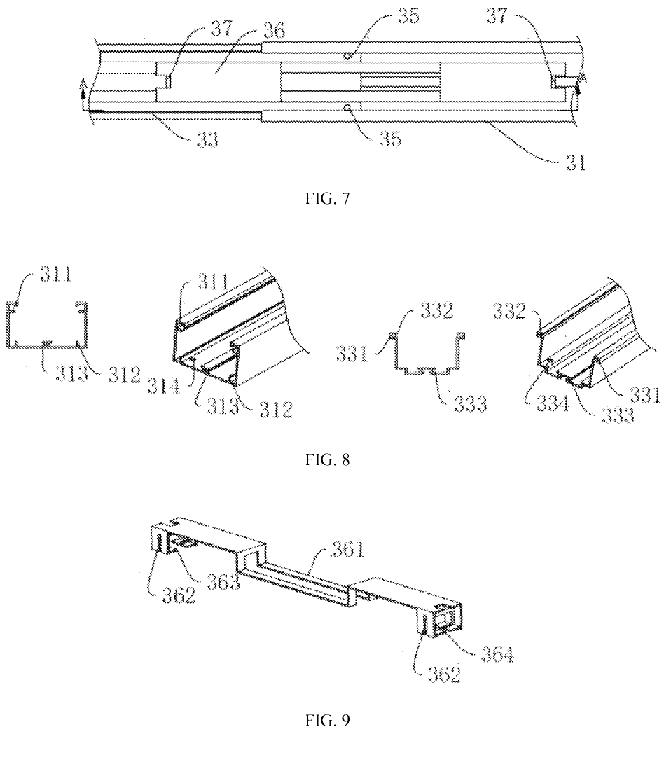

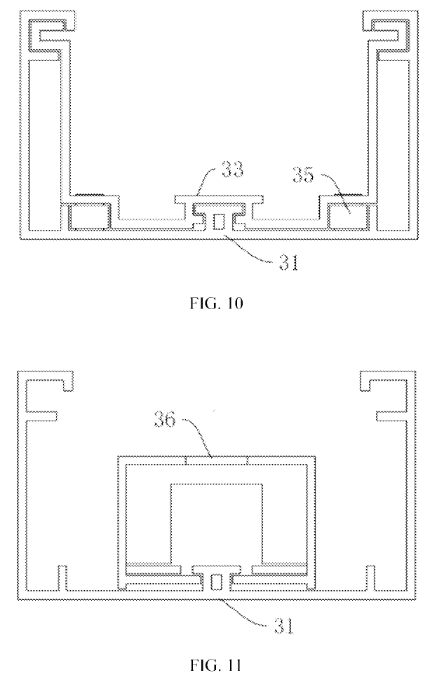

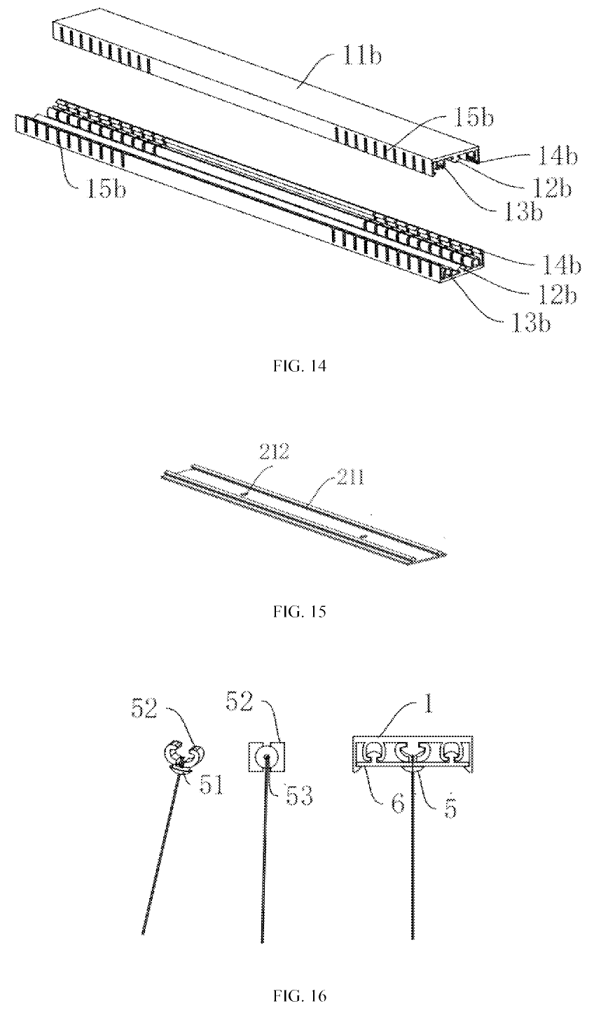

Referring to FIGS. 1 to 20, the present invention provides a sliding curtain with an adjustable width mechanism. The sliding curtain with adjustable width comprises an adjustable upper rail assembly 1, a light-shielding assembly 2, a telescopic lower rail assembly 3, and a pull cord driving device 4. The adjustable upper rail assembly 1 includes a main body portion and an adjustable portion connected to the main body portion, wherein the width of the adjustable portion is adjustable. The adjustable upper rail assembly 1 is configured to be mounted on the upper surface of a window frame. The light-shielding assembly 2 is mounted on the adjustable upper rail assembly 1. The telescopic lower rail assembly 3 is located below the light-shielding assembly 2 and is connected to the light-shielding assembly 2, with its width being adjustable. The pull cord driving device 4 is connected to the adjustable upper rail assembly 1, the light-shielding assembly 2, and the telescopic lower rail assembly 3, and is configured to control the lifting and lowering of the telescopic lower rail assembly 3.

It should be noted that the pull cord driving device 4 is known in the prior art. Specifically, the pull cord driving device 4 is embedded within the telescopic lower rail assembly 3, and pull cords extending from both sides of the device pass through the light-shielding assembly 2 to connect with the adjustable upper rail assembly 1. The pull cord driving device 4 is configured to control the lifting and lowering of the telescopic lower rail assembly 3.

In the present embodiment, the top end of the light-shielding assembly 2 is fitted with and connected to the adjustable upper rail assembly 1, and the bottom end of the light-shielding assembly 2 is fitted with and connected to the telescopic lower rail assembly 3.

In this embodiment, the width of the telescopic lower rail assembly 3 corresponds one-to-one with the width of the adjustable upper rail assembly 1.

### Embodiment 1

Referring to FIGS. 1 to 11, a sliding curtain with an adjustable width mechanism is provided, comprising an adjustable upper rail assembly 1, a light-shielding assembly 2, a telescopic lower rail assembly 3, and a pull cord driving device 4. The adjustable upper rail assembly 1 includes a main body portion and an adjustable portion connected to the main body portion, wherein the width of the adjustable portion is adjustable. The adjustable upper rail assembly 1 is configured to be mounted on the upper surface of a window frame. Specifically, the main body portion is a middle rail 11, and the adjustable portion is a side rail 12. The side rails 12 are slidably connected to the middle rail 11, with a side rail 12 provided at each end of the middle rail 11. The width of the adjustable upper rail assembly 1 can be adjusted by sliding the two side rails 12 inward or outward relative to the middle rail 11. The light-shielding assembly 2 is mounted on the adjustable upper rail assembly 1. The telescopic lower rail assembly 3 is located below the light-shielding assembly 2 and is connected thereto, with its width also being adjustable. The pull cord driving device 4 is connected to the adjustable upper rail assembly 1, the light-shielding assembly 2, and the telescopic lower rail assembly 3, and is configured to control the lifting and lowering of the telescopic lower rail assembly 3.

As a specific implementation of the present invention, the sliding curtain with adjustable width further comprises a cord buckle 5, which is configured to fix the tail end of a pull cord to the surface of the top plate. When the top plate is inserted into the top plate groove, the cord buckle 5 is simultaneously engaged in the cord buckle groove to increase the stability of the force points, preventing deformation of the top plate and detachment of the adjustable upper rail assembly 1.

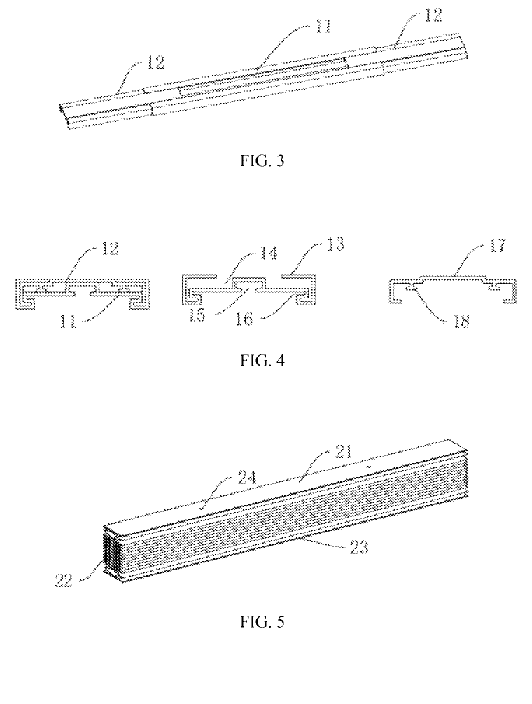

In this embodiment, the middle rail 11 forms the central main body portion of the adjustable upper rail assembly 1. The middle rail 11 is provided with a top surface of middle rail 13, which is flush and configured to facilitate adhesion to the upper surfaces of the window frame or door frame. Referring to FIG. 4, both sides of the middle rail 11 cross-section form an outer enclosing structure. The enclosed portions define side rail sliding grooves 14 for sliding connection with the side rails 12. The central section of the middle rail 11 cross-section is provided with a cord buckle groove 15 for fixing the cord buckle 5, and below the cord buckle groove 15 is a top plate groove 16, which is configured to receive the top plate of the light-shielding assembly 2. The side rails 12 are disposed at both ends of the middle rail 11 and are slidably connected within the side rail sliding grooves 14. The width of the adjustable upper rail assembly 1 is adjusted by sliding the side rails 12 inward. Each side rail 12 is provided with a top surface of side rail 17, which is flush with the top surface of middle rail 13 for adhesion to the window or door frame surfaces. Two symmetrical supporting sliding ribs 18 are disposed below both sides of the top surface of side rail 17 to enhance the strength of the side rails 12, reduce deformation, and improve sliding support. The supporting sliding ribs 18 serve to reduce friction between the side rails 12 and the middle rail 11 and to increase the rigidity of the side rails 12.

Referring to FIG. 5, the light-shielding assembly 2 includes a top plate 21, a curtain fabric 22, and a bottom plate 23. The top plate 21 is configured to connect with the adjustable upper rail assembly 1 and is provided with multiple wire holes 24. The curtain fabric 22 is mounted on the top plate 21 for light blocking or adjustment. The bottom plate 23 is connected to the end of the curtain fabric 22 opposite to the top plate 21 and is also provided with multiple wire holes 24.

Specifically, the light-shielding assembly 2 is located below the adjustable upper rail assembly 1. The top end is provided with the top plate 21, which is inserted into the top plate groove 16 of the middle rail 11. Below the top plate 21 is the curtain fabric 22, which may comprise, but is not limited to, honeycomb fabric, pleated fabric, or slat blinds. The bottom end of the curtain fabric 22 is provided with the bottom plate 23, which is installed in the bottom plate groove of the inner wall of the telescopic lower rail assembly 3. Both the top plate 21 and the bottom plate 23 are strip-shaped rigid plates, which function to drive the curtain fabric 22 to expand when the telescopic lower rail assembly 3 moves downward. Several wire holes 24 extend from the top plate 21 to the bottom plate 23 on both sides of the light-shielding assembly 2, through which the pull cords extending from the pull cord driving device 4 pass.

As a specific implementation of the present invention, referring to FIGS. 5 to 11, the telescopic lower rail assembly 3 comprises a bracket 36, an outer rail 31, and an inner rail 33. The bracket 36 is adapted to the pull cord driving device 4. The outer rail 31 is slidably connected to the bracket 36, and the inner rail 33 is slidably connected to both the outer rail 31 and the bracket 36, such that the outer rail 31 and the inner rail 33 can slide relative to each other while the bracket 36 remains stationary. In this embodiment, one end of the outer rail 31 is provided with an outer rail end cap 32, and one end of the inner rail 33 is slidably connected to the outer rail 31 at the end opposite to the outer rail end cap 32. The other end of the inner rail 33 is provided with an inner rail end cap 34. One end of the outer rail 31 and inner rail 33 that are connected is provided with a snap-fit 35. The telescopic lower rail assembly 3 is located below the light-shielding assembly 2 and is specifically installed on the bottom plate 23. The telescopic lower rail assembly 3 adopts a double-layer track telescopic structure, with the outer layer formed by the outer rail 31 and the inner layer formed by the inner rail 33. A bracket 36 is disposed inside the assembly to cooperate with the pull cord driving device 4. The outer rail 31 and the inner rail 33 are slidably connected and also slidably connected to the bracket 36, allowing them to slide inward relative to each other while the bracket 36 remains stationary, thereby adjusting the width of the telescopic lower rail assembly 3. The snap-fit 35 is disposed at one end where the outer rail 31 and inner rail 33 are connected, while the opposite end is provided with an end cap to prevent the bottom plate 23 from slipping out.

Specifically, the upper inner walls of both sides of the outer rail 31 are provided with upper sliding grooves 311. The inner rail 33 includes a sliding arm 331, which cooperates with the upper sliding grooves 311. The central portion of the outer rail 31 bottom plate is provided with a first lower sliding groove 313 to cooperate with the low-position sliding rib 364 of the bracket 36. Both sides of the bottom plate of the outer rail 31 are provided with snap-fit stop ribs 312 for limiting movement. One end edge of the outer rail 31 is provided with a first snap-fit hole 314, which is adapted to the outer rail end cap 32. The upper sliding grooves 311 cooperate with the sliding arm of the inner rail 33 to allow sliding. The snap-fit stop ribs 312 secure the snap-fit and prevent its movement. The first lower sliding groove 313 cooperates with the inner rail 33 and bracket 36 for sliding. The first snap-fit hole 314 is used to install a snap-fit.

On the outer side above the inner rail 33, the sliding arm 331 cooperates with the upper sliding grooves 311 of the outer rail 31. The inner side of the inner rail 33 is provided with a bottom plate groove 332 to receive the bottom plate 23 of the light-shielding assembly 2. Above the bottom plate of the inner rail 33, a second lower sliding groove 333 is provided to cooperate with the high-position sliding rib 363 of the bracket 36, and one end edge of the inner rail 33 is provided with a second snap-fit hole 334. The sliding arm 331 allows sliding with the upper sliding grooves 311 of the outer rail 31, the bottom plate groove 332 is for mounting the bottom plate 23, the second lower sliding groove 333 cooperates with the bracket 36, and the second snap-fit hole 334 is used for installing a snap-fit.

The bracket 36 is provided in the middle with a limiting groove 361 for connecting and fixing the pull cord driving device 4. One end of the bracket 36 bottom is provided with a high-position sliding rib 363 to cooperate with the first lower sliding groove 313, and the other end bottom is provided with a low-position sliding rib 364 to cooperate with the lower sliding groove of the outer rail 31. Both the high-position sliding rib 363 and low-position sliding rib 364 are provided with a longitudinal turning groove for installing a turning shaft 37, which is configured for changing the direction of the pull cord. The outer rail 31 is configured to install the inner rail, the bracket, and the bottom plate. The outer rail end cap 32 prevents the bottom plate from sliding out of the outer rail and covers the outer rail. The inner rail 33 cooperates with the outer rail 31 and is configured to install the bracket 36 and the curtain fabric 22. The inner rail end cap 34 prevents the bottom plate from sliding out of the inner rail and covers the inner rail. The snap-fit 35 prevents separation between the inner rail and the outer rail. The bracket 36 provides fixing of the pull cord driving device, change of pull cord direction, and relative sliding of the inner rail and outer rail.

### Embodiment 2

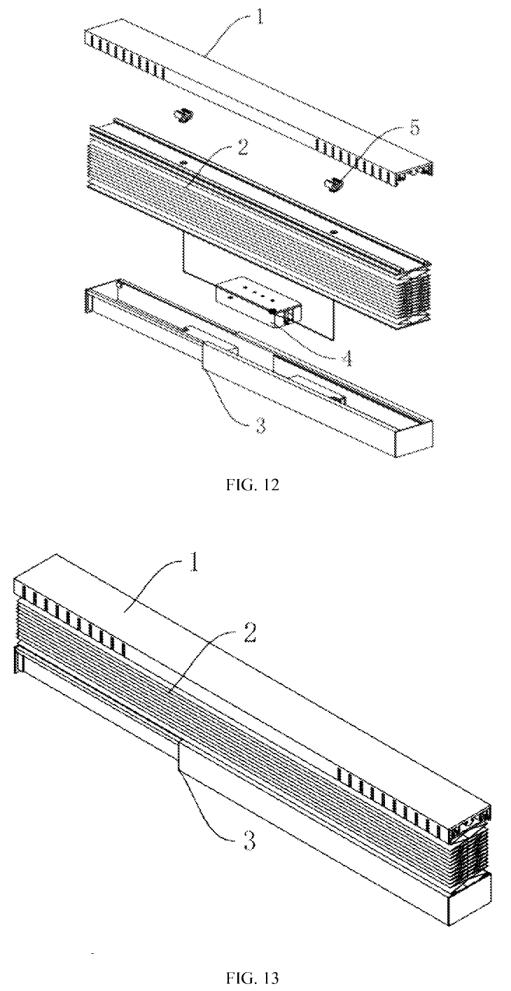

Referring to FIGS. 12 to 16, a sliding curtain with adjustable width mechanism comprises a adjustable upper rail assembly 1, a light-shielding assembly 2, a telescopic lower rail assembly 3, and a pull cord driving device 4. The adjustable upper rail assembly 1 includes a main body and an adjustable portion connected to the main body, and the width of the adjustable portion is adjustable. The adjustable upper rail assembly 1 is configured to be installed on the upper surface of a window frame. Specifically, the main body is a plate structure, and the adjustable portion is a rail section 15b. Both ends of the plate structure are provided with the rail section 15b, which comprises multiple connected segment bodies. The length of the rail section 15b can be adjusted by breaking off individual segment bodies, thereby achieving width adjustment of the adjustable upper rail assembly 1. The light-shielding assembly 2 is installed on the adjustable upper rail assembly 1; the telescopic lower rail assembly 3 is located below the light-shielding assembly 2 and is connected thereto. The width of the telescopic lower rail assembly 3 is adjustable. The pull cord driving device 4 is connected to the adjustable upper rail assembly 1, the light-shielding assembly 2, and the telescopic lower rail assembly 3, and is configured to control the lifting and lowering of the telescopic lower rail assembly 3.

As a specific implementation of this embodiment, the adjustable upper rail assembly 1 is located at the top of the curtain, with the light-shielding assembly 2 installed thereon. The second top surface 11b of the adjustable upper rail assembly 1 can be adhered to the upper surface of a window frame or door frame. Beneath the adjustable upper rail assembly 1 is a lower rib 12b for cooperating with the cord buckle 5. On both sides, C-shaped grooves 13b are provided for cooperating with the light-shielding assembly 2, and inwardly projecting sidewall snap-fits 14b are provided below the sidewalls of the adjustable upper rail assembly 1, which are configured to secure the top plate 21. Both ends of the main body are provided with multiple segment bodies of equal width, which are connected to form the rail section 15b. The sidewalls of the segment bodies are disconnected from the C-shaped grooves 13b. The width of the adjustable upper rail assembly 1 can be reduced by breaking off several segment bodies, thereby achieving adjustment of the width.

As a specific implementation of this embodiment, the light-shielding assembly 2 is located below the adjustable upper rail assembly 1, with its top end being the top plate 21. Below the top plate 21 are the curtain fabric 22 and the bottom plate 23, which are the same as in Example 1, and therefore are not described in detail here.

The surface of the top plate 21 is provided with two upper ribs 211 that cooperate with the C-shaped grooves 13b of the adjustable upper rail assembly 1. When the upper ribs 211 engage with the C-shaped grooves 13b, the sidewall snap-fits 14b simultaneously secure the edges of the top plate 21, thereby completing the assembly of the top plate 21. The surface of the top plate 21 is also provided with multiple cord holes 212 for passing the pull cord and cooperating with the cord buckle 5. The top plate 21 provides support for the curtain fabric 22, facilitates its unfolding, and fixes the cord buckle 5. The upper ribs 211 are configured to engage with the C-shaped grooves 13b of the adjustable upper rail assembly 1, and the cord holes 212 are configured for passing the pull cord and securing the cord buckle.

The cord buckle 5 comprises a dome-shaped snap 51, above which is a C-shaped snap 52, and a through cord hole 53 extending vertically. After the pull cord passes through the cord hole 53 from below and is fixed, the dome-shaped snap 51 is inserted into the cord hole 212 of the top plate 21 and engaged therewith. The C-shaped snap 52 is then engaged with the lower rib 12b of the adjustable upper rail assembly 1, thereby completing a dual fixation of the adjustable upper rail assembly 1 and the top plate 21 to increase the stability of the force points and prevent deformation of the top plate 21 or detachment from the adjustable upper rail assembly 1.

It should be noted that the telescopic lower rail assembly, pull cord driving device, and cord buckle are the same as those in Embodiment 1, and therefore are not described in detail here.

### Embodiment 3

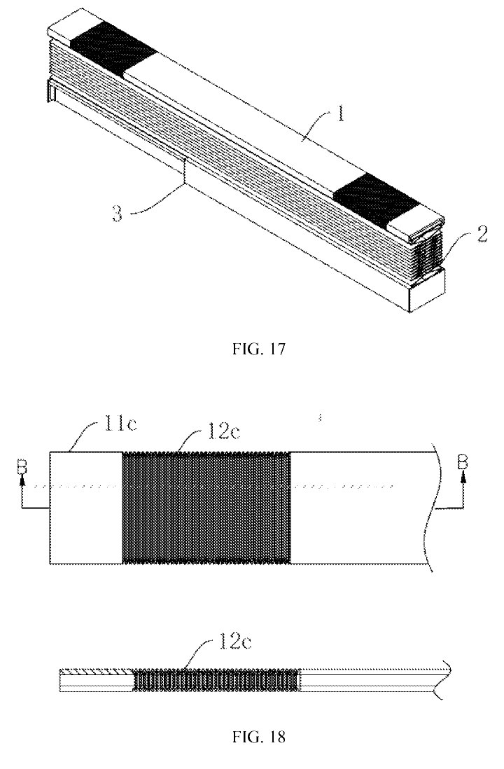

Referring to FIGS. 17 to 18, a sliding curtain with adjustable width mechanism comprises an adjustable upper rail assembly 1, a light-shielding assembly 2, a telescopic lower rail assembly 3, and a pull cord driving device 4. The adjustable upper rail assembly 1 includes a main body and an adjustable portion connected thereto, and the width of the adjustable portion is adjustable. The adjustable upper rail assembly 1 is configured to be installed on the upper surface of a window frame. Specifically, the main body is a plate structure, and the adjustable portion is a foldable soft rail 12c. The adjustable upper rail assembly 1 is located at the top of the curtain, with the light-shielding assembly 2 installed thereon. The third top surface 11c of the adjustable upper rail assembly 1 can be adhered to the upper surface of a window frame or door frame. Both ends of the main body are provided with a section of the foldable soft rail 12c, which is composed of multiple pleats arranged to allow lateral expansion or stacked contraction. The light-shielding assembly 2 is installed on the adjustable upper rail assembly 1; the telescopic lower rail assembly 3 is located below the light-shielding assembly 2 and is connected thereto. The width of the telescopic lower rail assembly 3 is adjustable. The pull cord driving device 4 is connected to the adjustable upper rail assembly 1, the light-shielding assembly 2, and the telescopic lower rail assembly 3, and is configured to control the lifting and lowering of the telescopic lower rail assembly 3.

It should be noted that the light-shielding assembly, telescopic lower rail assembly, pull cord driving device, and cord buckle are the same as in Embodiment 1 and are not described again.

### Embodiment 4

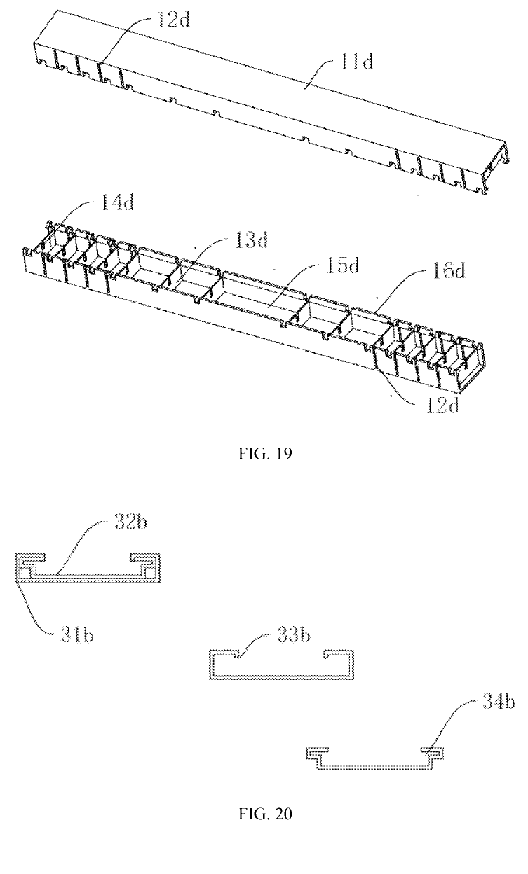

Referring to FIGS. 19 to 20, a sliding curtain with adjustable width mechanism comprises an adjustable upper rail assembly 1, a light-shielding assembly 2, a telescopic lower rail assembly 3, and a pull cord driving device 4. The adjustable upper rail assembly 1 includes a main body and an adjustable portion connected thereto, and the width of the adjustable portion is adjustable. The adjustable upper rail assembly 1 is configured to be installed on the upper surface of a window frame. Specifically, the main body is a plate structure, and the adjustable portion is a foldable soft rail 12c. The adjustable upper rail assembly 1 is located at the top of the curtain, with the light-shielding assembly 2 installed thereon. The top surface 11c of the adjustable upper rail assembly 1 can be adhered to the upper surface of a window frame or door frame. Both ends of the main body are provided with a section of the foldable soft rail 12c, which is composed of multiple pleats arranged to allow lateral expansion or stacked contraction. The light-shielding assembly 2 is installed on the adjustable upper rail assembly 1; the telescopic lower rail assembly 3 is located below the light-shielding assembly 2 and connected thereto. The width of the telescopic lower rail assembly 3 is adjustable. The pull cord driving device 4 is connected to the adjustable upper rail assembly 1, the light-shielding assembly 2, and the telescopic lower rail assembly 3, and is configured to control the lifting and lowering of the telescopic lower rail assembly 3.

As a specific implementation of this embodiment, the adjustable upper rail assembly 1 is located at the top of the curtain, with the light-shielding assembly 2 installed thereon. The fourth top surface 11d of the adjustable upper rail assembly 1 can be adhered to the upper surface of a window frame or door frame. Both ends of the adjustable upper rail assembly 1 are provided with multiple second rail sections 12d of equal width, with the sidewalls of adjacent second rail sections 12d disconnected. The width of the adjustable upper rail assembly 1 can be reduced by breaking off several second rail sections 12d, thereby achieving width adjustment. The adjustable upper rail assembly 1 internally includes multiple baffles 13d for partitioning. The outer edge of the rail sections 12d is provided with baffles to enclose the rail sections, and wire grooves 14d are provided at the lower-middle positions of the baffles 13d for passing the pull cord. A central limiting groove 15d is provided to cooperate with the pull cord driving device 4. Sidewall snap-fits 16d are provided below the sidewalls of the adjustable upper rail assembly 1 to secure the top plate 21.

As a specific implementation of this embodiment, the telescopic lower rail assembly 3 is located below the light-shielding assembly 2 and installed on the bottom plate 23. The telescopic lower rail assembly 3 is a dual-layer telescopic structure, comprising a second outer rail 31b and a second inner rail 32b. The second outer rail 31b is provided with a bottom plate positioning rib 33b, which limits the second inner rail 32b. The lower surface of the bottom plate positioning rib 33b is flush with the positioning groove 34b of the inner rail's bottom plate to avoid height differences between the dual-layer telescopic structure and the bottom plate 23. The second inner rail 32b is provided with a bottom plate groove 34b for installing the bottom plate 23, and the lower surface of the bottom plate groove 34b is flush with the bottom plate positioning rib 33b, also to avoid height differences.

It should be noted that the light-shielding assembly, pull cord driving device, and cord buckle are the same as in Embodiment 1 and are not described again.

The present invention provides a sliding curtain with adjustable width mechanism. Compared with the prior art, the present invention provides a sliding curtain whose width can be adjusted. Both the upper and lower rails of the curtain are of a modular adjustable structure, allowing the rails to contract inward according to the width of the cut curtain fabric, thereby achieving overall width adjustment of the curtain. This design overcomes the problem in the prior art where the width of spring-operated sliding curtains cannot be adjusted.

The above descriptions are merely preferred embodiments of the present invention and are not intended to limit the scope of the present invention. Any modifications, equivalent substitutions, or improvements made within the spirit and principle of the present invention shall fall within the scope of protection of the present invention.

What is claimed is:

1. A sliding curtain with adjustable width mechanism, comprising:
an adjustable upper rail assembly, including a main body portion and an adjustable portion connected to the main body portion, wherein a width of the adjustable portion is adjustable; the adjustable upper rail assembly is configured for installation on a surface of a window frame;
a light-shielding assembly, mounted on the adjustable upper rail assembly;
a telescopic lower rail assembly, located below the light-shielding assembly, wherein the telescopic lower rail assembly is connected to the light-shielding assembly, and a width of the telescopic lower rail assembly is adjustable;
a pull-cord driving device, connected to the adjustable upper rail assembly, the light-shielding assembly, and the telescopic lower rail assembly, wherein the pull-cord driving device is configured to control raising and lowering of the telescopic lower rail assembly.

2. The sliding curtain with adjustable width mechanism according to claim 1, wherein the main body portion is a middle rail, the adjustable portion is a side rail, and the side rail is slidably connected to the middle rail; width adjustment is achieved by sliding the side rail inwardly or outwardly relative to the middle rail.

3. The sliding curtain with adjustable width mechanism according to claim 1, wherein the main body portion is a plate structure, the adjustable portion is a rail section, the rail section is connected to the plate structure, and the rail section includes a plurality of connected segment bodies; the length of the rail section can be adjusted by breaking the segment bodies.

4. The sliding curtain with adjustable width mechanism according to claim 1, wherein the adjustable portion is a foldable soft rail, at least one end of the main body portion is provided with the foldable soft rail, the foldable soft rail comprises a plurality of pleats arranged in sequence, and the foldable soft rail can be laterally expanded or contracted and stacked.

5. The sliding curtain with adjustable width mechanism according to claim 1, wherein the telescopic lower rail assembly comprises:
a second inner rail, provided with a bottom plate groove for connection with the light-shielding assembly;
a second outer rail, sleeved on the second inner rail and slidably connected to the second inner rail, wherein the second outer rail is provided with a bottom plate positioning rib for limiting the second inner rail.

6. The sliding curtain with adjustable width mechanism according to claim 1, wherein the telescopic lower rail assembly comprises:
a bracket, adapted to the pull-cord driving device;
an outer rail, slidably connected to the bracket;
an inner rail, slidably connected to the outer rail and the bracket; the outer rail and the inner rail are capable of relative sliding while the bracket remains stationary.

7. The sliding curtain with adjustable width mechanism according to claim 3, further comprising a cord fastener, wherein the cord fastener includes:
a dome-shaped snap,
a C-shaped snap positioned above the dome-shaped snap, the C-shaped snap having a through hole extending vertically;
wherein after a pull cord of the pull-cord driving device passes through and is fixed below the through hole, the dome-shaped snap is engaged with the light-shielding assembly, and the C-shaped snap is engaged with the adjustable upper rail assembly, thereby achieving bidirectional fixation of the adjustable upper rail assembly and the light-shielding assembly.

8. The sliding curtain with adjustable width mechanism according to claim 1, wherein a bottom end of the light-shielding assembly is engaged with the telescopic lower rail assembly.

9. The sliding curtain with adjustable width mechanism according to claim 1, wherein a top end of the light-shielding assembly is engaged with the adjustable upper rail assembly.

10. The sliding curtain with adjustable width mechanism according to claim 4, wherein the telescopic lower rail assembly comprises:
a second inner rail, provided with a bottom plate groove for connection with the light-shielding assembly;
a second outer rail, sleeved on the second inner rail and slidably connected to the second inner rail, wherein the second outer rail is provided with a bottom plate positioning rib for limiting the second inner rail.
